(19) United States
(12) Patent Application Publication
(10) Pub. No.: US 2026/0043205 A1
(43) Pub. Date: Feb. 12, 2026

(54) PORTABLE ICE MELTING DEVICE

(71) Applicant: Wensky Azard, Spring Valley, NY (US)

(72) Inventor: Wensky Azard, Spring Valley, NY (US)

(21) Appl. No.: 19/366,510

(22) Filed: Oct. 22, 2025

Related U.S. Application Data
(63) Continuation-in-part of application No. 18/445,538, filed on Sep. 29, 2023.

(51) Int. Cl. E01H 5/10; B25G 1/04; B25G 3/38

(52) U.S. Cl. CPC E01H 5/102; B25G 1/04; B25G 3/38

(57) ABSTRACT

An improved portable ice melting device comprises an extendable handle assembly for adjustable length and a melting assembly. The handle assembly features a pivot adaptor, enabling the melting assembly to rotate and lock at multiple angles for versatile use on various surfaces. The melting assembly includes an open-ended metallic housing lined with an insulating material and an electrical wire heating element. A power cord connects the heating element to a portable power source, directing thermal energy through the housing's open end to melt ice. This design enhances portability, versatility across diverse surfaces, and efficiency for non-mechanical ice removal.

### CROSS REFERENCE TO RELATED APPLICATION

This application is a Continuation in Part of U.S. patent application Ser. No. 18/445,538, filed on Sep. 29, 2023, which application is incorporated by reference herein in its entirety.

### FIELD OF THE INVENTION

The invention relates to an improved portable ice melting device comprising an extendable handle rod assembly and melting assembly.

### BACKGROUND

The accumulation of ice and snow on surfaces such as walkways, walls, and vehicle exteriors can present significant hazards and inconveniences. Various attempts have been made to address this issue, particularly in the automotive field. Conventional solutions often involve devices that combine thermal energy with mechanical force.

For instance, U.S. Pat. No. 5,357,646 discloses a heated ice scraper for a vehicle having an electrically heated blade and removable brush. Similarly, U.S. Pat. No. 5,973,294 is directed to a heated windshield scraper device for removing ice from a windshield. While these devices are capable of melting ice on automotive glass, they possess significant limitations that restrict their utility.

A primary deficiency of conventional heated scrapers is their lack of versatility. They are specifically designed for the geometry of vehicle windshields and are not suitable for clearing ice from a broader range of surfaces, including but not limited to, ground surfaces, walls, or other irregular and angular surfaces. Moreover, the portability of such devices is typically constrained, as they rely on a connection to the vehicle's electrical system, rendering them inoperable away from the vehicle. Another significant drawback is the potential for surface damage wherein the integrated scraper can cause abrasions and scratches on the underlying surface, particularly on glass, if not operated with care.

In light of the foregoing, there is a clear need in the art for a portable and versatile ice melting device that can be used on a multitude of surface types and geometries without being tethered to a vehicle and without the inherent risk of causing surface damage associated with mechanical scraping.

Thus, a heretofore unaddressed need exists in the industry to address the aforementioned deficiencies and inadequacies.

### SUMMARY

The objective of this invention is to produce an improved ice melting device which quickly and effectively melts ice present on the ground, walls, and angular surfaces when connected to a portable power source.

According to a preferred embodiment of the invention, an ice melting device is provided, comprising an extendable handle assembly, a pivot mount assembly, a pivot adaptor, and a melting assembly. The extendable handle assembly includes an outer rod and an inner rod telescopically received within the outer rod, and further comprises at least one length adjustment locking mechanism, preferably at least one flip tab mechanism (hereinafter “flip tab”), configured to secure the length adjustment of the handle assembly, thereby allowing its length to be adjusted. The pivot mount assembly is attached to a distal end of the extendable handle assembly and comprises a pivot tab defining a pivot through-hole and a plurality of locking through-holes. This pivot mount assembly is configured to allow angular adjustment and locking of the melting assembly at multiple angular positions (e.g., 0°, 45°, 90°) relative to the extendable handle assembly via lock pins. The melting assembly, which is attached to the pivot adaptor, further comprises an open-ended metallic housing, an insulating material lining interior surfaces of said housing, and an electrical wire heating element positioned within said housing and configured to generate thermal energy. A power cord is electrically connected to said heating element and adapted to connect to a portable power source, thereby supplying an electrical current to generate said thermal energy, which is then directed towards an ice surface through the open end of said housing. This embodiment provides a versatile, portable, and non-mechanical solution for melting ice on various surfaces, addressing the limitations of conventional ice melting devices.

According to a preferred embodiment of the invention the portable power source comprises a rechargeable battery. This embodiment enhances the portability and convenience of the device, allowing operation in locations without access to fixed power outlets. In other embodiments, the device may be plugged into a fixed power outlet or extension cord.

According to a preferred embodiment of the invention said extendable handle assembly comprises an outer rod and an inner rod telescopically received within said outer rod, and further comprises at least one flip tab mechanism configured to secure the length adjustment of said extendable handle assembly. This embodiment allows operators to adjust the length of the handle assembly according to their specific needs, providing significant flexibility in reaching ice surfaces at various distances or heights.

The melting assembly comprises a metallic rectangular box with an open bottom end. The top of the melting assembly showcases an adaptor fastened to the top of the open-ended rectangular box. The interior of the metallic box may be coated with a ceramic or metallic insulation to reflect the heat emitted from the heating element downwards onto the surface. In some embodiments, insulation may be padded insulation composed of ceramic or metallic materials. In other embodiments, insulation may be spray coated onto the interior surface of the melting assembly housing.

According to a preferred embodiment of the invention said insulating material comprises ceramic or metallic materials and/or combination thereof. This embodiment reflects thermal energy downward toward the ice surface while protecting the operator from excessive heat and improving overall energy efficiency.

In one aspect, an electrical wire heating element is positioned within the housing and configured to generate thermal energy sufficient to melt ice on contact. The heating element is strategically positioned to maximize heat distribution across the open end of the housing for optimal ice melting performance.

According to a preferred embodiment of the present invention, the electrical wire heating element comprises a resistive heating wire selected from a nickel-chromium alloy or iron-chromium-aluminum alloy. This embodiment provides a robust and efficient heat source for melting ice.

The present disclosure relates to an improved portable ice melting device that addresses limitations of conventional ice melting devices by providing versatility for use on various surfaces beyond vehicle windshields, true portability through compatibility with portable power sources, and a non-mechanical approach to ice removal that prevents surface damage.

In one aspect, the melting assembly connects to the handle assembly via a pivot adaptor and pivot mount assembly with multiple through-holes that allow the melting assembly to rotate and lock at various angles including 0°, 45°, and 90° positions relative to an operator, enabling adaptation to different surface orientations such as ground, walls, and angular surfaces. This embodiment ensures stable positioning of the melting assembly at various operational angles, enhancing adaptability to different surface orientations.

According to a preferred embodiment of the invention said melting assembly further comprises a protective grille guard positioned across the open end of said metallic housing. This embodiment prevents direct contact between the heating element and the ice surface while still allowing efficient heat transfer, enhancing both safety and durability.

According to a preferred embodiment of the invention said electrical wire heating element is arranged in a serpentine pattern within said metallic housing. This embodiment maximizes heat distribution across the open end of the housing for optimal ice melting performance.

According to a preferred embodiment of the invention said power cord comprises at least two electrical wires encased in insulating sheaths and flame retardant cable grommets for securing said electrical wires within said melting assembly. This embodiment ensures safe and organized electrical connections, handling the electrical current required by the heating element without overheating.

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

Further areas of applicability will become apparent from the description provided herein. It should be understood that the description and specific examples are intended for purposes of illustration only and are not intended to limit the scope of the present disclosure.

Based on the explanation stated above, the invention may be embodied in the form illustrated in the accompanying drawings. However, the drawings are illustrative only as variations are contemplated as being part of the invention, limited only by the scope of the claims.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The present invention and the manner in which it may be practiced is further illustrated with reference to the accompanying drawings wherein:

FIG. 1 illustrates a perspective view of the handle assembly in an extended embodiment, in accordance with an embodiment of the present disclosure;

FIG. 2 illustrates a perspective view of the handle assembly in a collapsed embodiment, in accordance with an embodiment of the present disclosure;

FIG. 3 illustrates a perspective view of the pivot adaptor, in accordance with an embodiment of the present disclosure;

FIG. 4 illustrates a top view of the melting assembly housing in accordance with an embodiment of the present disclosure;

FIG. 5 illustrates a perspective view of the pivot adaptor mounted to the melting assembly housing, in accordance with an embodiment of the present disclosure;

FIG. 6 illustrates a perspective view of the wire holder, in accordance with an embodiment of the present disclosure;

FIG. 7 illustrates a perspective view of the melting assembly housing interior, in accordance with an embodiment of the present disclosure;

FIG. 8A illustrates an exploded view of the melting assembly with protective grille guard, in accordance with an embodiment of the present disclosure;

FIG. 8B illustrates a perspective view of a melting assembly interior without protective grille guard, in accordance with an embodiment of the present disclosure;

FIG. 9 illustrates a perspective view of the improved portable ice melting device in a collapsed embodiment, in accordance with an embodiment of the present disclosure;

FIG. 10 illustrates the device having the melting assembly positioned in a 45° angle from the operator, in accordance with an embodiment of the present disclosure; and

FIG. 11 illustrates the device having the melting assembly positioned in a 90° angle from the operator, in accordance with an embodiment of the present disclosure.

### DETAILED DESCRIPTION OF THE EMBODIMENTS

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents. The components in the figures are not necessarily to scale, emphasis instead being placed upon illustrating various preferred embodiments of the invention.

It should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

The ice melting device, hereinafter “device 100,” of the present disclosure includes an extendable handle assembly, hereinafter “handle assembly 114,” and a melting assembly, both of which are integral to its functionality. The handle assembly is a pivotal component that allows an operator to adjust the length of the handle assembly according to their specific needs, thereby providing significant flexibility in reaching ice surfaces that may be located at various distances or heights. This adaptability is achieved through the incorporation of telescoping segments within the handle assembly, which may be securely locked using flip tabs at different telescopic segments to maintain the desired length during operation, ensuring stability and ease of use.

The combination of the extendable handle assembly and the melting assembly allows operators to effectively remove ice from various surfaces without the physical exertion required by traditional ice removal methods. The device is particularly useful for removing ice from elevated areas, delicate surfaces where mechanical removal might cause damage, or in situations where chemical de-icers are not appropriate. The portable nature of the power supply makes the device suitable for use in areas without fixed electrical outlets.

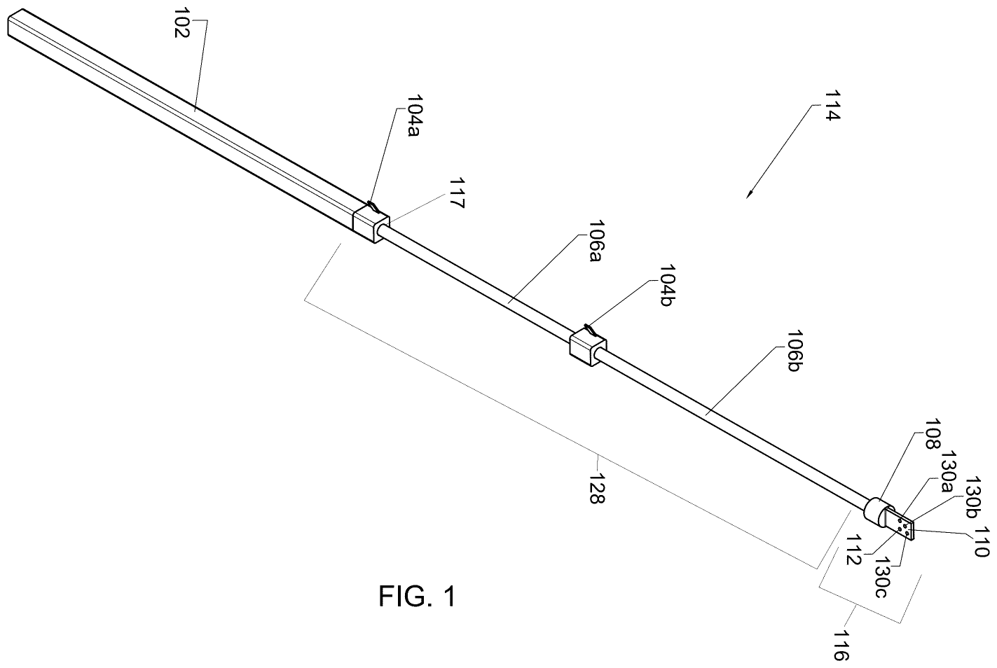

FIG. 1 illustrates the handle assembly 114 in its extended state, the handle assembly 114 comprises an outer rod 102 and an inner rod 128 wherein the inner rod 128 is formed by at least two telescopically arranged segments, a first telescopic segment 106a and second telescopic segment 106b. The outer rod 102 is located on the proximal end of the handle assembly 114 and is configured to be grasped by the hand of an operator. In some embodiments, the outer rod 102 may be designed as a cylindrical, square, or another shape capable of being grasped in the hand of an operator. In a preferred embodiment, the outer rod 102 is constructed of a rigid plastic or metal material at least partially encased by an outer layer of a second material configured to form an exterior gripping surface or ergonomic grip to improve operator comfort and control during extended operation periods. In other embodiments, the outer rod 102 is not encased by an outer layer of a second material or ergonomic grip. In a preferred embodiment, the outer rod 102 further comprises an internal longitudinal cavity extending the length of the outer rod 102 and an aperture 117 on the distal end of the outer rod 102 through which the inner rod 128 may be extended through from its collapsed embodiment or retracted through from its extended embodiment.

In preferred embodiments, the inner rod 128 is a telescopic shaft formed by at least two hollow telescopic segments 106a-b wherein the second telescopic segment 106b is smaller in diameter to the first telescopic segment 106a to enable the second telescopic segment 106b to be collapsed within the first telescopic segment 106a. In some embodiments, the second telescopic segment 106b may be hollow or solid. In further embodiments, the inner rod 128 may be fixed (non-telescopic) or comprise of more than two telescopic segments wherein each telescopic segment has a progressively smaller diameter than the preceding telescopic segment, allowing each telescopic segment to nest one within the other telescopic segment when retracted.

In preferred embodiments, the extended length of the device 100 is twelve feet. In some embodiments, the telescopic segments 106a-b are of equal length. In other embodiments, each of the telescopic segments 106a-b may be of different lengths relative to one another. In further embodiments, inner rod 128 may comprise of more than two telescopic segments.

The handle assembly 114 may be extended or collapsed based on the desired length of an operator. The length of the handle assembly 114 may be adjusted by at least one flip tab 104a-b located on the proximal ends of the first telescopic segment 106a and second telescopic segment 106b which further secures the telescopic segments 106a-b at a desired length, preventing unintended collapse or extension during use. When an operator lifts up a flip tab 104a-b on one of the telescopic segments 106a-b, the corresponding telescopic segment 106a-b may be extended or collapsed to the operator's needs.

As illustrated in FIG. 1, a first flip tab 104a is located on the proximal end of the first telescopic segment 106a and second flip tab 104b is located on the proximal end of the second telescopic segment 106b. To lock the position of an extended or collapsed telescopic segment 106a-b, the operator may press the flip tab 104a-b downward. When the handle assembly 114 is fully collapsed, the flip tabs 104a-b remain in a downward position to lock the telescopic segments 106a-b in a closed position. To extend the handle assembly 114 from a collapsed state, the flip tabs 104a-b are lifted up in order for the telescopic segments 106a-b to extend outward. Once at the desired length, the flip tabs 104a-b are then pressed downward to lock the telescopic segments 106a-b in place. FIG. 1 illustrates the handle assembly 114 in an extended position with the flip tabs 104a-b in a downward position thus locking the extended telescopic segments 106a-b in place.

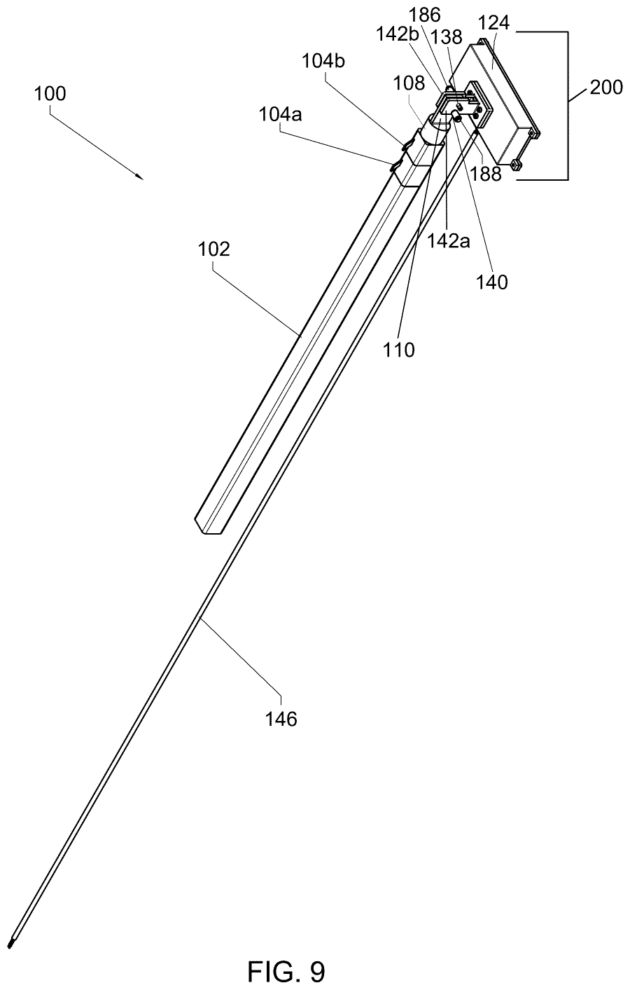

In a preferred embodiment, a pivot mount assembly 116 comprising a pivot tab 110 and pivot base 108 is integrally welded to the distal end of the second telescopic segment 106b. In other embodiments, the pivot base 108 may be removably secured to the second telescopic segment 106b via a threaded engagement between a threaded hole in the pivot base 108 and a corresponding threaded distal end of the second telescopic segment 106b. In an embodiment, the pivot tab 110 is constructed of rigid plastic or metallic materials of a substantially planar design comprising a pivot through-hole 112 and at least one locking through-hole 130a-c extending through a first and second surface of the pivot tab 110. The pivot through-hole 112 is configured to accept a first lock pin 188 and the at least one locking through-hole 130a-c configured to accept a second lock pin 186, as further illustrated in FIG. 9. In preferred embodiments, the pivot tab 110 comprises four total through-holes including a pivot through-hole 112 and three locking through-holes 130a-c, each positioned to allow the device 100 to be utilized at different angles. In an embodiment, the connection of the first lock pin 188 through the pivot through-hole 112 serves as a fixed axle, allowing the melting assembly to rotate freely around the pivot through-hole 112. Additional through-holes 130a-c serve as angular locking positions at an angle selected by the operator. In a preferred embodiment, a second lock pin 186 passed through locking through-hole 130a enables the melting assembly to be positioned at a 90° angle relative to the operator, through locking through-hole 130b positioned at a 45° angle from the operator, and through locking through-hole 130c positioned at a 0° angle from the operator. In an embodiment, the first and second lockpins 186, 188 are unthreaded.

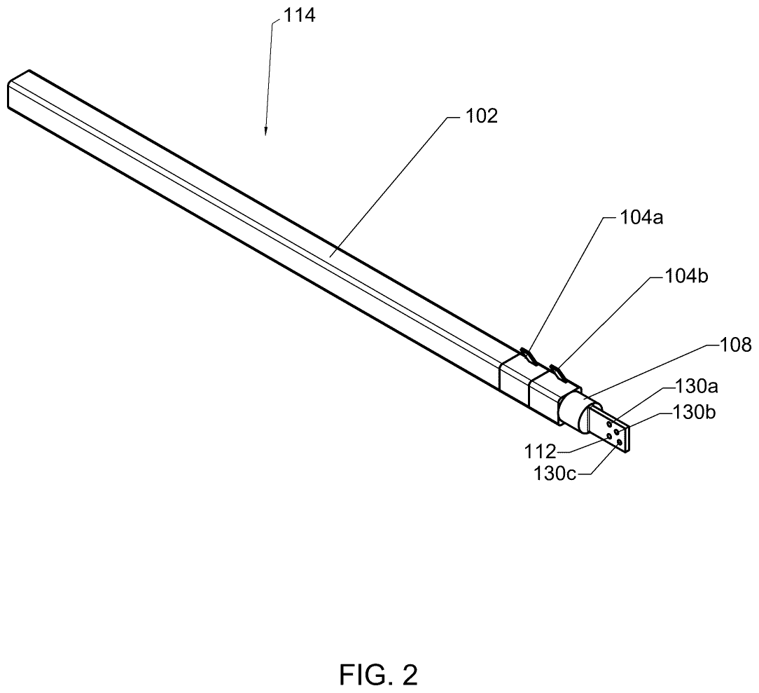

FIG. 2 illustrates the handle assembly 114 in its collapsed embodiment having both flip tabs 104a-b in the closed position to prevent the inner rod 128 from extending from the internal longitudinal cavity of the outer rod 102. In collapsed embodiments, the inner rod 128 is housed within the internal longitudinal cavity of the outer rod 102.

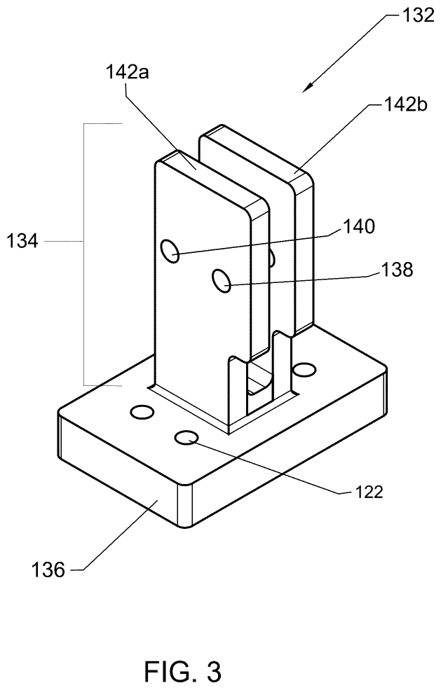

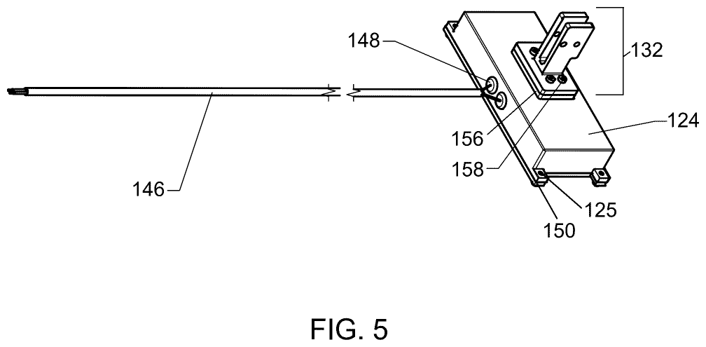

FIG. 3 illustrates the pivot adaptor 132 comprising a pivot adaptor base 136 and pivot adaptor mount 134 in accordance with an embodiment of the present invention. The pivot adaptor base 136 comprises a plurality of mounting through-holes 122 for securing the pivot adaptor base 136 to corresponding threaded holes 126 on the melting assembly mount 156 using fasteners 158 such as a bolt or screw as further illustrated in FIG. 5. The pivot adaptor mount 134 is integrally machined to the top surface of the pivot adaptor base 136 such that the pivot adaptor mount 134 pivot adaptor base 136 are monolithic and is generally U-shaped, comprising two parallelly aligned arms 142a-b. Each arm 142a-b comprises a pivot mount through-hole 140 and at least one locking mount through-hole 138 in alignment with corresponding through-holes 138, 140 on the parallel arm 142a-b. As further illustrated in FIG. 9, an first lock pin 188 is passed through the pivot mount through-hole 140 on each parallel arm 142a-b and second locking pin 186 is passed through the locking mount through-hole 138 on each parallel arm 142a-b in order to secure the pivot adaptor 132 to the pivot tab 110. In a preferred embodiment, the at least one locking mount through-hole 138 and pivot mount through-hole 140 are unthreaded.

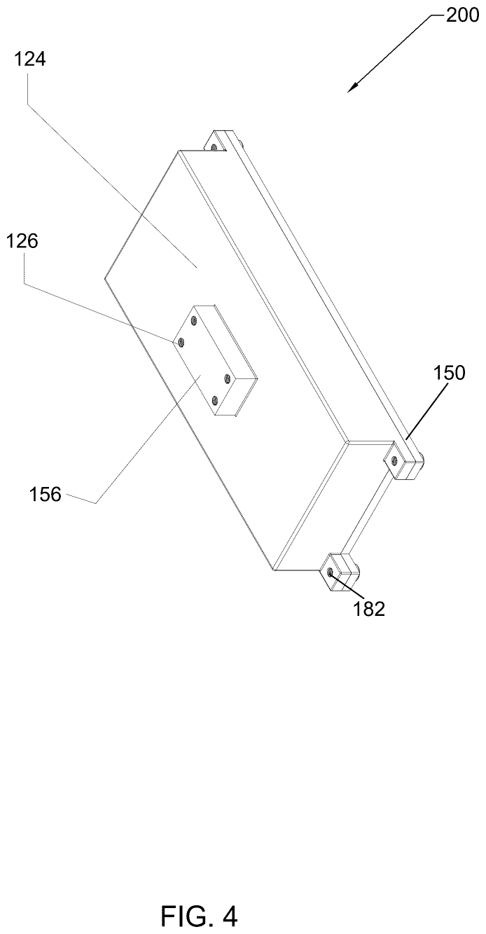

FIG. 4 illustrates a top view of the melting assembly housing 124 comprising a melting assembly mount 156 integrally molded to the top of the melting assembly housing 124 in accordance with an embodiment of the present invention. The melting assembly mount 156 comprises a first plurality of threaded holes 126, wherein the first plurality of threaded holes 126 are configured to coaxially align with a second plurality of mounting through-holes 122 on the pivot adaptor base 136 wherein both the threaded holes 126 and mounting through-holes 122 are configured to receive one or more fasteners 158 for mechanically coupling the pivot adaptor base 136 to the melting assembly mount 156, as further illustrated in FIG. 5.

FIG. 5 illustrates the pivot adaptor 132 mounted to melting assembly housing 124. In an embodiment, the power supply cord 146 comprises sheathing for enclosing and organizing at least two electrical wires 196, the electrical wires 196 further encased in insulating outer sheathing 198. The mounting assembly housing 124 further comprises at least two flame retardant cable grommets 148 used to hold the electrical wire 196 and outer sheathing 198 inside of the melting assembly housing 124. The electrical wires 196 of the power supply cord 146 are designed with appropriate gauge wiring to handle the electrical current required by the heating element 160 without overheating. The electrical wire 196 is composed of wire having a high melting point including resistance wire, such as kanthal, nichrome, and related wire suitable for sustaining a high heat over a set period of time.

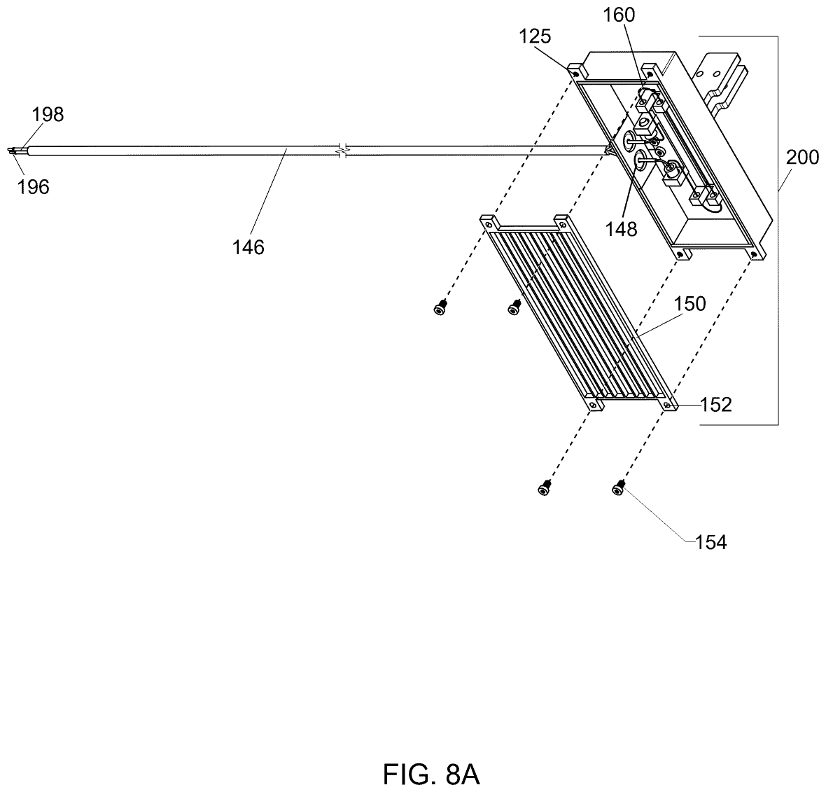

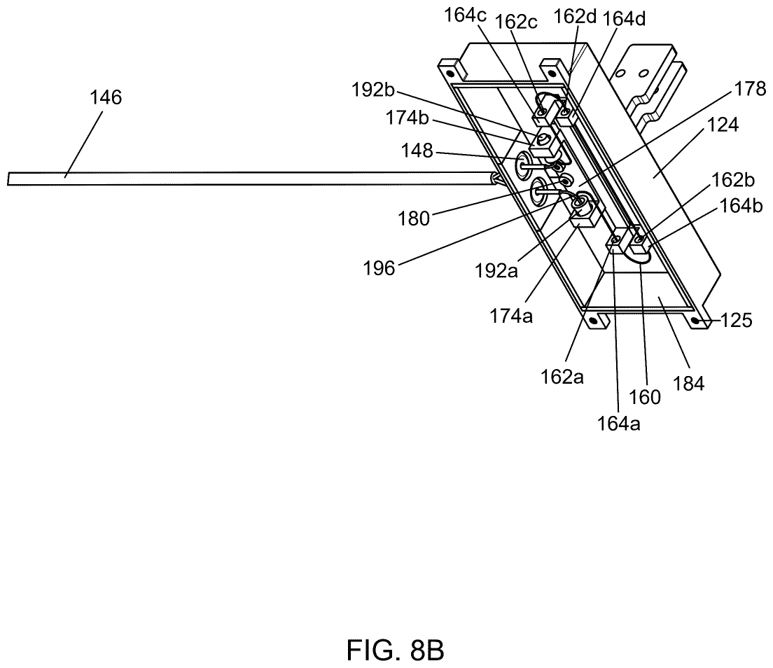

The power supply cord 146 extends from the melting assembly 200 along, or through, the handle assembly 114 and is adapted to connect to a portable power source (not illustrated). The connection of the power supply cord 146, specifically the electrical wires 196, and portable power sources allows electrical current to flow to the heating element 160, as further illustrated in FIG. 8B, generating the thermal energy necessary for melting ice.

When in operation, an operator connects the power supply cord 146 to a portable power source such as a battery pack, generator, or other suitable electrical supply. Once powered, the heating element 160 quickly reaches operating temperature, generating thermal energy that radiates through the open end of the melting assembly housing 124 and protective grille guard 150, as further illustrated in FIG. 8A. The operator can then position the melting assembly 200 against an ice surface. The thermal energy transfers directly to the ice, causing it to melt on contact.

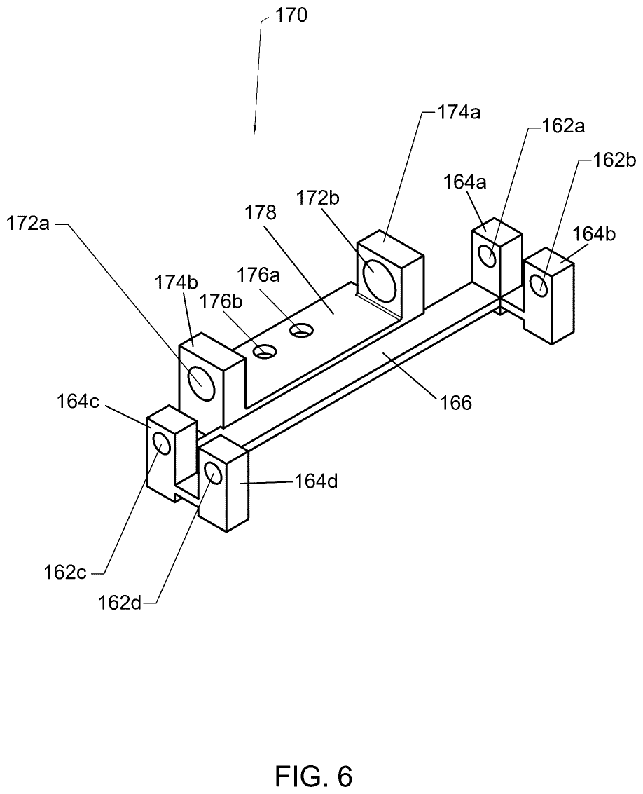

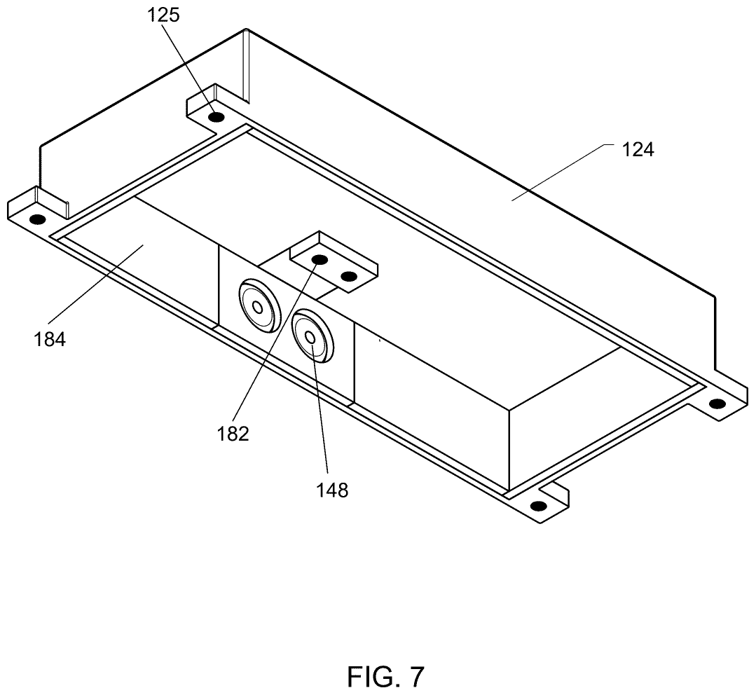

FIG. 6 illustrates a wire holder 170, in accordance with an embodiment of the present invention. The wire holder 170 comprises a wire holder bracket 178 and heating element bracket 166. In preferred embodiments, the wire holder 170 is a monolithic piece constructed of metallic or ceramic materials and/or a combination of ceramic and metallic materials such as aluminum, stainless steel, or related metals. Wire holder bracket 178 further comprises parallelly aligned wire holder arms 174a-b on opposite ends of the wire holder bracket 178. Each wire holder arm 174a-b comprises a wire holder through hole 172a-b for supporting wire nut connectors 192a-b as further illustrated in FIG. 8B. Wire holder bracket 178 further comprises at least one wire holder mount through-holes 176a-b through the planar surface of the wire holder bracket 178. Wire holder mount through-holes 176a-b secure the wire holder 170 to corresponding threaded housing mount holes 182 of the melting assembly housing 124 as further illustrated in FIGS. 7 and 8B using threaded fasteners 180 such as screws and the like. Heating element bracket 166 further comprises a plurality of heating element arms 164a-d for supporting the heating element 160 passed through heating element through holes 162a-d on each arm 164a-d and maintaining its shape as further illustrated in FIG. 8B. In other embodiments, the wire holder 170 may be of any shape, configurations, and/or materials suitable for holding the electrical wire 196 and heating element 160 within the melting assembly housing 124.

FIG. 7 illustrates the interior of the melting assembly housing 124 having threaded housing mount holes 182 on the underside of the melting assembly housing 124 as well as insulation 184, in accordance with an embodiment of the present invention. The interior surfaces of the melting assembly housing 124 are lined with insulation 184. Insulation 184 may be made of materials having a high-heat tolerance and properties effective for reflecting heat such as ceramics or related materials. In some embodiments, the insulation 184 is spray coated onto the interior surface of the melting assembly housing 124. Insulation 184 serves multiple critical functions within the melting assembly housing 124. Firstly, the insulation 184 prevents heat loss through the sides and back of the melting assembly housing 124, directing thermal energy primarily through the open end toward the ice surface. Secondly, the insulation 184 protects the handle assembly 114 from excessive heat transfer, thereby ensuring operator safety during operation. Thirdly, insulation 184 improves the overall energy efficiency of the device by concentrating heat where it is needed most, thus enhancing the device's performance.

Each corner of the melting assembly housing 124 includes a protrusion defining a housing corner threaded hole 125. Each housing corner threaded hole 125 is adapted to align with a corresponding grille guard through hole 152 of the protective grille guard 150 to receive a threaded screw 154, as further illustrated in FIG. 8A.

FIG. 8A illustrates an exploded view of a melting assembly housing interior with protective grille guard and FIG. 8B illustrates a perspective view of a melting assembly housing interior without protective grille guard, in accordance with embodiments of the present disclosure. In an embodiment, melting assembly 200 comprises the melting assembly housing 124 and its internal components as well as the protective grille guard 150.

The power supply cord 146 includes at least two insulated electrical wires 196 and outer sheathing 198. FIGS. 8A and 8B show the heating element 160 configured in a serpentine pattern through heating element through-holes 162a-d and supported by heating element arms 164a-d. Wire nut connectors 192a-b secured within the wire holder arms 174a-b connect the electrical wires 196 to the heating element 160. A protective grille guard 150 is attached to the housing 124 via threaded screws 154 through grille guard through holes 152 and housing corner threaded hole 125 as illustrated in FIG. 8A.

In an embodiment, electrical wires 196, preferably two insulated electrical wires, are each covered by a respective outer sheathing 198. In some embodiments, the outer sheathing 198 may be constructed of ceramic, silicone rubber, Fiberglass, Mica-glass, or related high temperature resilient materials and/or combination thereof. In other embodiments, a combination of the provided sheathing materials may be used depending on the use case. The at least two electrical wires 196 are grouped together and housed within the outer sheathing 198 in order to organize them. Each individual wire 196 is passed through two separate flame retardant cable grommets 148. Each electrical wire 196 is secured within a wire nut connector 192a-b, which is, in turn, nested within a corresponding wire holder through hole 172a, 172b. Within a first wire nut connector 192a, one end of electrical wire 196 is electrically coupled to a first end of the heating element 160. The heating element 160 is composed of a resistive heating wire, such as a nickel-chromium alloy (e.g., Nichrome) or an iron-chromium-aluminum alloy (e.g., Kanthal).

A second end of the heating element 160 is looped through each of the heating element through holes 162a-d and electrically coupled to a second end of electrical wire 196 in a second wire nut connector 192b. In some embodiments, ends of the electrical wire 196 are electrically coupled to the ends of the heating element 160 in the wire nut connectors 192a-b prior to mounting the wire holder 170 to the melting assembly housing 124. In a preferred embodiment, the heating element 160 is configured in a serpentine pattern through each of the heating element through holes 162a-d to maximize the heating surface area within the confines of the melting assembly housing 124, providing more uniform heat distribution across the open face of the melting assembly 200.

The heating element 160 is secured within the melting assembly housing 124 in a manner that prevents direct contact with either the melting assembly housing 124 or the insulation 184, maintaining optimal operational safety and efficiency.

In some embodiments, wire nut connectors 192a-b are secured to the wire holder mount through holes with a high temperature epoxy or other adhesive means.

The protective grille guard 150 is securable to the melting assembly housing 124 via a plurality of threaded screws 154. In some embodiments, various threaded screw alternatives and/or materials may be utilized such as low to high profile screws. Each corner of the melting assembly housing 124 comprises a protrusion having a housing corner threaded hole 125 which aligns with a corresponding grille guard through hole 152 on the protective grille guard 150 to receive one of the threaded screws 154. In preferred embodiments, the protective grille guard 150 is preferably made of a rigid metallic material, such as aluminum, stainless steel, or related metals and/or a combination thereof suitable for repeated application to surfaces and high-temperature applications.

In alternative embodiments, the melting assembly housing 124 may be configured in various shapes, including, but not limited to, circular, rectangular, or other polygonal profiles, provided that the melting assembly housing 124 defines an open-ended structure.

The melting assembly 200, which is attached to a distal end of the handle assembly 114 via the pivot adaptor 132, serves as the primary functional component for melting ice. The flat configuration of the protective grille guard 150 provides a flat surface area that can be applied directly to ice surfaces, ensuring maximum contact and efficient melting.

FIG. 9 illustrates device 100 in a collapsed embodiment, in accordance with an embodiment of the present invention. In certain embodiments, the lock pins 186, 188 may be tethered to the handle assembly 114 to prevent their inadvertent loss. The tether may comprise a flexible member, including, but not limited to, a chain, a rope, a cable, or a lanyard. In other embodiments, lock pins 186, 188 are not fixed to the handle assembly 114. In this embodiment, the melting assembly 200 is positioned in a 0° angle from the operator, in accordance with an embodiment of the present disclosure. In an embodiment, lock pins 186, 186 are passed through aligned through-holes of the pivot tab 110 and both of the parallelly aligned arms 142a-b.

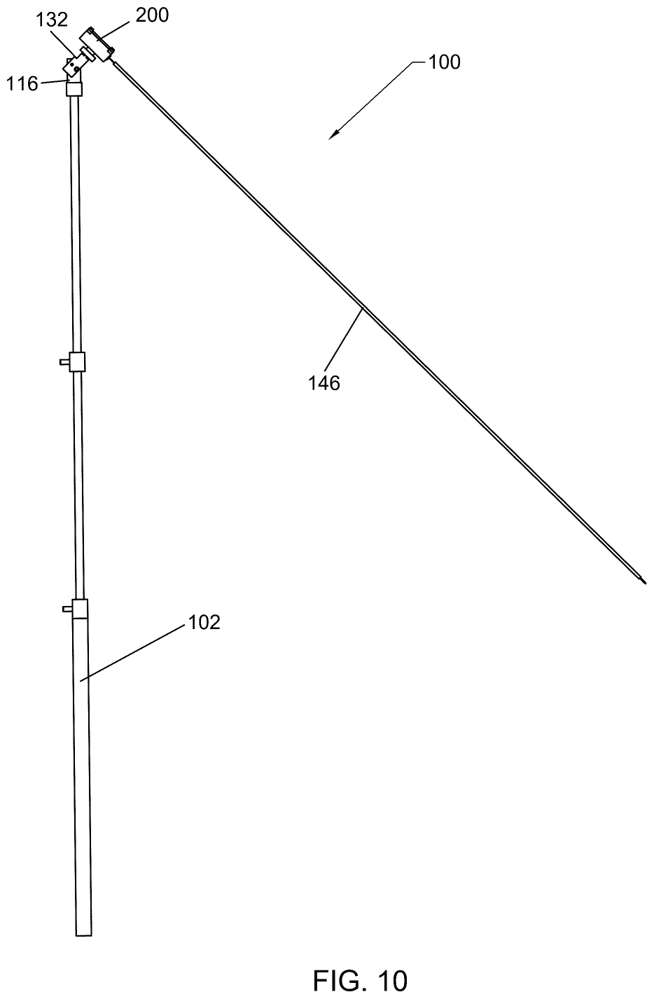

FIG. 10 illustrates the device 100 having the melting assembly 200 positioned in a 45° angle from the operator, in accordance with an embodiment of the present disclosure.

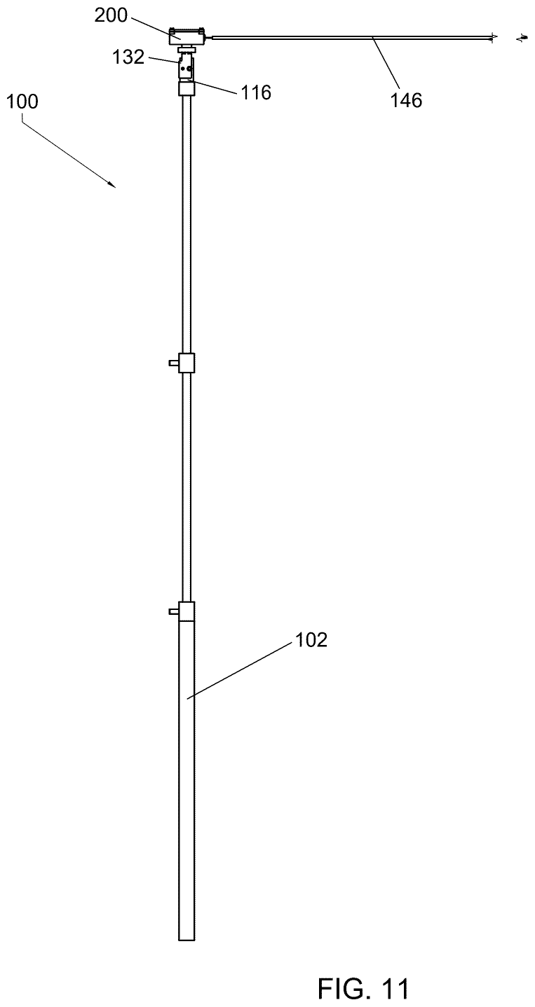

FIG. 11 illustrates the device 100 having the melting assembly 200 positioned in a 90° angle from the operator, in accordance with an embodiment of the present disclosure.

FIGS. 5, 8A, and 11 illustrate break lines in the power supply cord 146.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An ice melting device, comprising:
(a) a handle assembly;
(b) a pivot mount assembly coupled to a distal end of the handle assembly, the pivot mount assembly defining a plurality of discrete angular orientations;
(c) a melting assembly, comprising:
(i) a housing having an open end and an interior;
(ii) an insulating material disposed on an interior surface of the housing;
(iii) a heating element for producing thermal energy situated within the interior of the housing;
(iv) a protective grille guard positioned across the open end of the housing; and
(v) a power supply cable electrically coupled to the heating element and adapted for connection to a power source; and
(d) a pivot adaptor coupled to the melting assembly, the pivot adaptor being detachably engageable with the pivot mount assembly for selectively mechanically fixing an angular position of the melting assembly relative to the handle assembly at one of the plurality of discrete angular orientations.

2. The ice melting device according to claim 1, wherein the power source comprises a rechargeable battery.

3. The ice melting device according to claim 1, wherein the handle assembly is an extendable handle assembly comprising an outer rod and an inner rod telescopically received within the outer rod, and a length adjustment locking mechanism.

4. The ice melting device according to claim 3, wherein the length adjustment locking mechanism comprises at least one flip tab mechanism.

5. The ice melting device according to claim 3, wherein the inner rod comprises at least two telescopic segments.

6. The ice melting device according to claim 5, wherein at least one of the at least two telescopic segments is hollow.

7. The ice melting device according to claim 3, wherein the outer rod is constructed of a rigid plastic or metal material at least partially encased by an outer layer of a second material forming an exterior gripping surface.

8. The ice melting device according to claim 4, wherein the at least one flip tab mechanism is located on proximal ends of telescopic segments of the extendable handle assembly.

9. The ice melting device according to claim 1, wherein the pivot mount assembly comprises a pivot tab, the pivot tab defining a pivot through-hole and a plurality of locking through-holes.

10. The ice melting device according to claim 9, wherein the pivot adaptor is detachably engageable with the pivot tab via a first unthreaded lock pin received in the pivot through-hole and a second unthreaded lock pin received in one of the plurality of locking through-holes.

11. The ice melting device according to claim 3, wherein the outer rod comprises an internal longitudinal cavity extending a length of the outer rod and an aperture on a distal end of the outer rod, the inner rod being extendable through the aperture.

12. The ice melting device according to claim 1, wherein the pivot adaptor further comprises a pivot adaptor base and a U-shaped pivot adaptor mount attached to the pivot adaptor base, the pivot adaptor mount having two parallelly aligned arms.

13. The ice melting device according to claim 1, wherein the plurality of discrete angular orientations includes 0 degrees, 45 degrees, and 90 degrees.

14. The ice melting device according to claim 1, wherein the housing is made of a metallic material and is a rectangular box.

15. The ice melting device according to claim 1, wherein the insulating material comprises ceramic materials, metallic materials, or a combination thereof.

16. The ice melting device according to claim 1, wherein the heating element comprises a resistive heating wire selected from a nickel-chromium alloy or an iron-chromium-aluminum alloy.

17. The ice melting device according to claim 16, wherein the heating element is arranged in a serpentine pattern within the interior of the housing, and further comprising a wire holder positioned within the interior of the housing, the wire holder supporting and positioning the heating element in the serpentine pattern.

18. The ice melting device according to claim 1, wherein the protective grille guard is securable to the housing via a plurality of threaded fasteners.

19. The ice melting device according to claim 18, wherein the protective grille guard comprises a rigid metallic material selected from aluminum or stainless steel.

20. The ice melting device according to claim 1, wherein the power supply cable comprises at least two electrical wires encased in an outer sheathing and flame retardant cable grommets for securing the electrical wires within the melting assembly.
